(19) United States
(12) Patent Application Publication
(10) Pub. No.: US 2009/0027323 A1
(43) Pub. Date: Jan. 29, 2009

(54) DISPLAY APPARATUS AND CONTROL METHOD THEREOF

(75) Inventor: Kyoung-oh CHOI, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/062,839

(22) Filed: Apr. 4, 2008

(30) Foreign Application Priority Data
Jul. 24, 2007 (KR) 10-2007-0073963

(51) Int. Cl. G09G 3/36

(52) U.S. Cl. 345/88; 345/89

(57) ABSTRACT

A display apparatus includes: a first display panel unit which comprises a color filter; a second display panel unit which faces the first display panel unit, and comprises a plurality of display blocks; a signal processor; and a controller which controls the signal processor to process an inputted image signal to be displayed on the first display panel, and to display a block image signal generated based on a gray scale of the image signal, on the second display panel unit.

### CROSS-REFERENCE TO RELATED APPLICATIONS

This application claims priority from Korean Patent Application No. 10-2007-0073963, filed on Jul. 24, 2007, in the Korean Intellectual Property Office, the disclosure of which is incorporated herein by reference.

### BACKGROUND OF THE INVENTION

1. Field of the Invention

Apparatuses and methods consistent with the present invention relate to a display apparatus and a control method thereof, and more particularly, to a display apparatus which includes two display panels, and a control method thereof.

2. Description of the Related Art

There are several kinds of display apparatuses. With the rapid progress in semiconductor technologies, a display apparatus including a liquid crystal display (LCD) panel has become popular since it is small and lightweight.

The display apparatus including the LCD panel has to a large extent, replaced the conventional cathode ray tube (CRT) since it is small, lightweight and consumes less power. In recent years, the LCD panel has been incorporated into almost every information processing device ranging from small devices such as a mobile phone, a personal digital assistant (PDA) and a portable multimedia player (PMP) to medium and large-sized devices such as a monitor and TVs.

A display apparatus including a liquid crystal display panel has its limitations in raising a contrast ratio. As the display apparatus including the LCD panel becomes larger in size, it requires a higher contrast ratio. Thus, the conventional display apparatus uses a polarizer or a functional film to improve the contrast ratio. However, the contrast ratio according to the conventional method and configuration depends on the characteristics of the polarizer or the functional film. However, deployment of the polarizer or the function film raises production costs.

### SUMMARY OF THE INVENTION

Accordingly, it is an aspect of the present invention to provide a display apparatus which improves a contrast ratio, and a control method thereof.

Also, it is another aspect of the present invention to provide a display apparatus which reduces production costs, and a control method thereof.

Further, it is another aspect of the present invention to provide a display apparatus which realizes local dimming by using two panels, and a control method thereof.

Additional aspects of the present invention will be set forth in part in the description which follows and, in part, will be obvious from the description, or may be learned by practice of the present invention.

The foregoing and/or other aspects of the present invention are also achieved by providing a display apparatus, including: a first display panel unit which includes a color filter; a second display panel unit which faces the first display panel unit, and includes a plurality of display blocks; a signal processor; and a controller which controls the signal processor to process an inputted image signal to be displayed on the first display panel, and to display a block image signal generated based on a gray scale of the image signal, on the second display panel unit.

The respective display blocks may include a plurality of pixels, and the gray scale of the block image signal is an intermediate gray scale value of the image signal corresponding to the pixels of the display blocks.

The second display panel unit may display an achromatic color image thereon.

The second display panel unit may include a passive matrix (PM) liquid crystal panel.

The second display panel unit may include a super twisted nematic mode (TN mode) liquid crystal panel.

The first display panel unit may include an active matrix (AM) liquid crystal panel which uses a thin film transistor (TFT).

The first display panel unit may include a vertically aligned (VA) mode liquid crystal panel.

The display apparatus may include a backlight assembly which supplies light to the first and second display panel units.

The backlight assembly may include at least one of a cold cathode fluorescent lamp (CCFL), an external electrode fluorescent lamp (EEFL) and a hot cathode fluorescent lamp (HCFL).

The foregoing and/or other aspects of the present invention are also achieved by providing a display apparatus, including: a first display panel unit which includes a color filter; a second display panel unit which faces the first display panel unit and is divided into a plurality of display blocks; a first image processor which processes an image signal to be displayed on the first display panel unit; a second image processor which generates a block image signal based on a gray scale of the image signal, the block image signal to be applied to the display blocks, and displays the block image signal on the second display panel unit; and a backlight assembly which supplies light to the first and second display panel units.

The second display panel unit may display an achromatic color image thereon.

The respective display blocks may include a plurality of pixels, and the gray scale of the block image signal is an intermediate gray scale value of the image signal corresponding to the pixels of the display blocks.

The second display panel unit may include a passive matrix (PM) liquid crystal panel.

The display apparatus include a user selection unit to adjust a contrast ratio.

The foregoing and/or other exemplary aspects of the present invention are also achieved by providing a control method of a display apparatus which includes a first display panel unit having a color filter, and a second display panel unit facing the first display panel unit and divided into a plurality of display blocks, the control method including: generating a predetermined block image signal based on a gray scale of an inputted image signal to be applied to the display blocks; and applying the image signal to the first display panel unit and applying the block image signal to the second display panel unit.

The respective display blocks may include a plurality of pixels, and the generating the block image signal includes calculating an intermediate gray scale value of the image signal corresponding to the pixels of the display blocks.

### BRIEF DESCRIPTION OF THE DRAWINGS

The above and/or other exemplary aspects of the present invention will become apparent from the following detailed description of exemplary embodiments thereof with reference to the accompanying drawings of which:

FIG. 1 is a block diagram of a display apparatus according to a first exemplary embodiment of the present invention;

FIG. 2 is sectional view of a display panel according to the first exemplary embodiment of the present invention;

FIG. 3 illustrates display block units of the display panel according to the first exemplary embodiment of the present invention;

FIG. 4 is a flowchart that describes a method of controlling the display apparatus according to the first exemplary embodiment of the present invention; and

FIG. 5 is a block diagram of a display apparatus according to a second exemplary embodiment of the present invention.

### DETAILED DESCRIPTION OF EXEMPLARY EMBODIMENTS

Hereinafter, exemplary embodiments of the present invention will be described with reference to accompanying drawings, wherein like numerals refer to like elements.

Also, well-known functions or constructions are not described in detail since they would obscure the invention with unnecessary detail.

Also, the drawings illustrate enlarged thickness of layers and regions to be clearly represented. The term “on” means that a new layer, film, region or panel may or may not be interposed between two layers, films, regions or panels, and the term “directly on” means that two layers, films, regions or panels contact each other without any layer, film, region or panel therebetween.

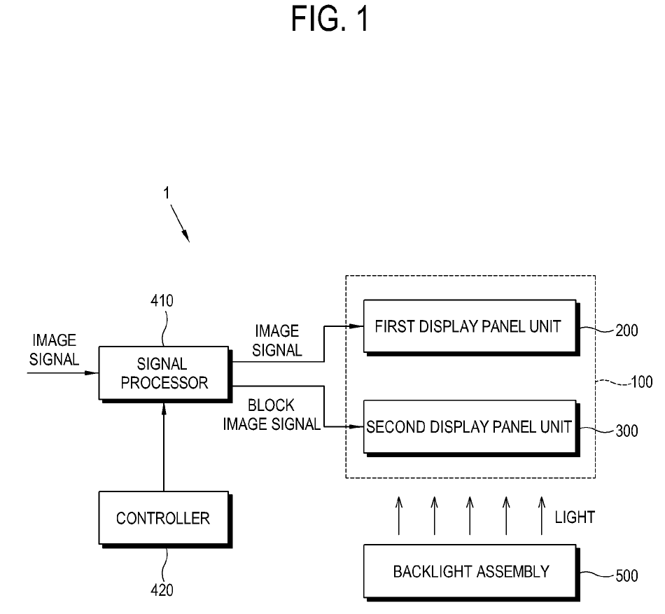

FIG. 1 is a block diagram of a display apparatus according to a first exemplary embodiment of the present invention.

As shown in FIG. 1, a display apparatus 1 according to the present exemplary embodiment includes a display panel 100, a signal processor 410, a controller 420 and a backlight assembly 500. The display panel 100 includes a first display panel unit 200 and a second display panel unit 300 facing the first display panel unit 200. The display apparatus 1 according to the present exemplary embodiment may include a liquid crystal display (LCD) apparatus which has the backlight assembly 500.

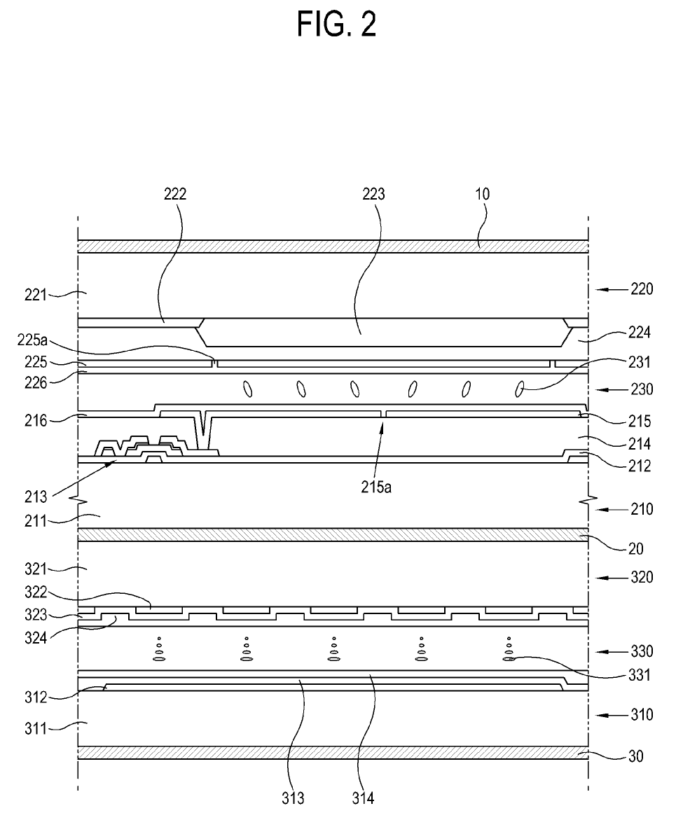

FIG. 2 is a sectional view of the display panel 100 according to the present exemplary embodiment. Hereinafter, the display panel 100 will be described in detail with reference to FIG. 2.

First, the first display panel unit 200 will be described. The first display panel unit 200 includes an active matrix (AM) liquid crystal display panel which uses a thin film transistor (TFT) 213. The thin film transistor 213 may be an amorphous silicon (a-Si) thin film transistor 213 formed by a five mask process. Alternatively, the first display panel unit 200 may use various types of thin film transistors 213.

The first display panel unit 200 includes a first panel 210, a second panel 220 and a first liquid crystal layer 230.

The first panel 210 includes a first substrate member 211 and several layers formed on the first substrate member 211. The first substrate member 211 includes a transparent material such as glass, quartz, ceramic or plastic. Gate wires which include a gate line, a storage electrode line and a gate electrode of the thin film transistor 213 are formed on the first substrate member 211. A gate insulating layer 212 is formed on the first substrate member 211 to insulate the gate wires.

Data wires which include a data line, a drain electrode and a source electrode of the thin film transistor 213 are formed on the gate insulating layer 212.

The gate wires and data wires include metal such as Al, Ag, Cr, Ti, Ta and Mo or an alloy thereof The gate wires and data wires may include a single layer or multiple layers including a metal layer such as Cr, Mo, Ti and Ta or an alloy thereof which have good physical and chemical properties, and a metal layer such as Al series or Ag series which have small specific resistance.

The thin film transistor 213 includes the gate electrode, the drain electrode, the source electrode and a semiconductor layer. A passivation layer 214 is formed on the thin film transistor 213. The passivation layer 214 includes an insulating material with a low permittivity such as a-Si:C:O and a-Si:O:F formed by a plasma enhanced chemical vapor deposition (PECVD) or an inorganic insulating material such as silicon nitride or silicon oxide.

A plurality of pixel electrodes 215 are formed on the passivation layer 214. The pixel electrodes 215 include a transparent conductive material such as indium tin oxide (ITO) or indium zinc oxide (IZO).

The pixel electrodes 215 include a domain dividing means to be divided into a plurality of domains. FIG. 2 illustrates a cutting pattern 215a as the domain dividing means which is formed by cutting a part of the pixel electrodes 215. Alternatively, the domain dividing means may vary to include other known methods such as a projection.

The second panel 220 includes a second substrate member 221 and a plurality of layers formed on the second substrate member 221. Like the first substrate member 211, the second substrate member 221 includes a transparent material such as glass, quartz, ceramic or plastic.

A black matrix 222 is formed on a side of the second substrate member 221 facing the first substrate member 211. The black matrix 222 includes an opening which faces the pixel electrodes 215, and blocks light leaking between neighboring pixels. The opening of the black matrix 222 is substantially smaller than the pixel electrodes 215. The black matrix 222 blocks external light from entering the semiconductor layer of the thin film transistor 213.

The black matrix 222 may include a metallic material or a photosensitive organic material added with an added black pigment to block light. The black pigment may include carbon black or titanium oxide.

A color filter 223 is consecutively disposed between the black matrices 222 on the second substrate member 221, and has red, green and blue color filters. The colors of the color filter 223 are not limited to the three primary colors, and may vary such that there is at least one color. In FIG. 2 the color filter 223 is formed on the second substrate member 221. Alternatively, the color filter 223 may be formed on the first substrate member 211.

A planarization layer 224 is formed on the black matrices 222 and the color filter 223. The planarization layer 224 may be removed.

A first common electrode 225 is formed on the planarization layer 224 to form an electric field together with the pixel electrodes 215. The first common electrode 225 includes a transparent conductive material such as ITO or IZO. The first common electrode 225 includes a domain dividing means to be divided into a plurality of domains.

A first alignment layer 216 and a second alignment layer 226 are respectively formed on the pixel electrodes 215 and the first common electrode 225 facing each other. The first liquid crystal layer 230 is disposed between the first and second alignment layers 216 and 226. The first liquid crystal layer 230 includes vertically aligned liquid crystal molecules 231. The first and second alignment layers 216 and 226 align the liquid crystal molecules 231 of the first liquid crystal layer 230 in a direction close to a vertical direction. That is, the first display panel unit 200 includes a vertically aligned (VA) mode liquid crystal display panel. In the VA mode, the longer side of the liquid crystal molecules 231 is vertically aligned with the first and second display panel units 200 and 300 while the electric field is not formed. A single pixel is divided into a plurality of domains in the VA mode liquid crystal display panel. The direction of the vertically aligned liquid crystal molecules 231 may be adjusted in various directions in the plurality of domains by using a fringe field. Thus, the liquid crystal panel in the VA mode may secure a wide viewing angle.

The liquid crystal molecules 231 of the first liquid crystal layer 230 are not limited to the VA mode. According to another exemplary embodiment, the first liquid crystal layer 230 may include twisted nematic (TN) liquid crystal molecules. In this case, the first and second alignment layers 216 and 226 align the longer side of the TN liquid crystal molecules to be parallel with the pixel electrodes 215 and the first common electrode 225 while twisting the center of the liquid crystal molecules. The TN mode first panel 210 provides faster response time and has a simple configuration while having a narrower viewing angle than the VA mode first panel 210. Also, the TN mode first panel 210 provides good productivity. The display apparatus 1 may further include a functional film such as a wide viewing angle compensation film other than polarizing plates 10 and 20, to improve the viewing angle of the first panel 210.

With the foregoing configuration, the first display panel unit 200 receives light from the backlight assembly 500 (refer to FIG. 1) and displays a substantially colorful image thereon.

Hereinafter, the second display panel unit 300 will be described in detail. The second display panel unit 300 may include one of an active matrix (AM) and a passive matrix (PM) liquid crystal display panels. The second display panel unit 300 according to the present exemplary embodiment does not include a color filter, and includes a passive matrix liquid crystal display panel. That is, pixels of the second display panel unit 300 do not include a thin film transistor. A common electrode and a scanning electrode 312 are formed in a grid pattern, and adjust alignment of liquid crystal molecules 331. An image signal which is applied to the second display panel unit 300 is synchronized with an image signal applied to the first display panel unit 200.

The second display panel unit 300 includes a third panel 310, a fourth panel 320 and a second liquid crystal layer 330.

The third panel 310 includes a third substrate member 311, and several layers formed on the third substrate member 311. The third substrate member 311 includes a transparent material such as glass, quartz, ceramic or plastic.

A scanning electrode 312 is formed on the third substrate member 311. The scanning electrode 312 includes a transparent conductive material such as ITO or IZO. A passivation layer 313 and a third alignment layer 314 are sequentially formed on the scanning electrode 312.

The fourth panel 320 includes a fourth substrate member 321 and several layers formed on the fourth substrate member 321. A second common electrode 322 is formed on the fourth substrate member 321. The second common electrode 322 also includes a transparent conductive material such as ITO or IZO, and crosses the scanning electrode 312 to form a pixel in a matrix pattern. A passivation layer 323 and a fourth alignment layer 324 are sequentially formed on the second common electrode 322.

The second liquid crystal layer 330 is disposed between the third and fourth alignment layers 314 and 324. The second liquid crystal layer 330 includes super twisted nematic (STN) mode liquid crystal molecules 331. The STN mode liquid crystal molecules 331 are twisted from 210° to 270° between the scanning electrode 312 and the second common electrode 322. Typically, the STN mode liquid crystal molecules 331 are twisted 270°, provide better brightness and contrast ratio and have faster response time.

According to the present exemplary embodiment, the second display panel unit 300 includes the STN mode liquid crystal display panel, but it is not limited thereto. According to another exemplary embodiment, the second liquid crystal layer 330 may include a guest-host liquid crystal layer. As the second display panel unit 300 expresses only black and white colors, it may include a display panel such as a guest-host liquid crystal display panel which has a simple configuration and is less expensive to manufacture. The guest-host liquid crystal display panel may be driven by an active matrix method including the thin film transistor or by a passive matrix method. If the second display panel unit 300 includes the guest-host liquid crystal panel, a third polarizing plate 30 may not be provided.

That is, the second display panel unit 300 may vary as long as it is capable of displaying an image in black and white colors. Preferably, the second display panel unit 300 has a relatively simple configuration and provides high productivity.

As described above, the second display panel unit 300 receives light from the backlight assembly 500 (refer to FIG. 1) and displays an image in an achromatic color including black and white colors. The second display panel unit 300 improves a contrast ratio of an image displayed on the first display panel unit 200. For example, the contrast ratios of the first and second display panel units 200 and 300 are 1000:1, respectively. It is assumed that 100% of the light passes through the first and second display panel units 200 and 300 without loss. If the first and second display panel units 200 and 300 operate in a normally black mode and if a voltage is not applied to the liquid crystal layers 330 and 230, light passes through the two display panel units 200 and 300 and decreases down to 1/1000. Meanwhile, if the first and second display panel units 200 and 300 receive a voltage and display white color, the amount of light passing through the two display panel units 200 and 300 becomes 1000. That is, the contrast ratio is 1000,000:1, which is a square of the respective contrast ratios (1000:1) of the display panel units 200 and 300.

The display panel 100 further includes first to third polarizing plates 10, 20 and 30. The first polarizing plate 10 is formed on a second surface of the second substrate member 221 having the color filter 223. The second polarizing plate 20 is disposed between the first and second display panel units 200 and 300. The third polarizing plate 30 is formed on a surface of the third substrate member 311 opposite to the one on which the scanning electrode 312 is formed. Here, a polarizing axis of the polarizer of the second polarizing plate 20 is perpendicular to those of the first polarizing plate 10 and the third polarizing plate 30. Polarizing axes of the first and third polarizing plates 10 and 30 are parallel with each other.

Returning to FIG. 1, the signal processor 410 processes an inputted image signal to be supported by the first and second display panel units 200 and 300. The signal processor 410 includes a scaler, a timing controller and a driver which applies various signals to the first and second display panel units 200 and 300.

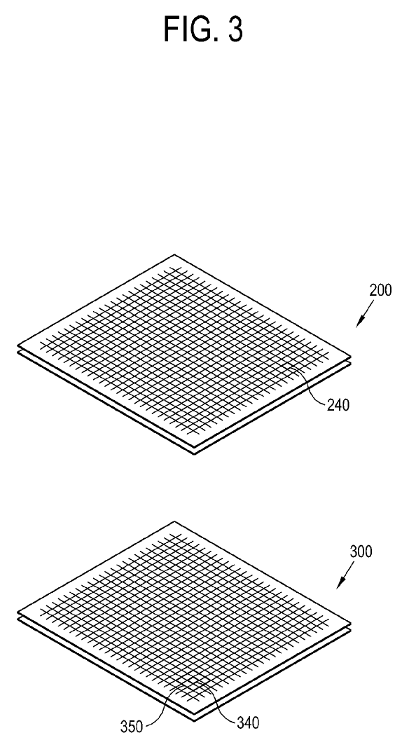

The controller 420 controls the signal processor 410 to display the inputted image signal on the first display panel unit 200 and to display a predetermined image pattern on the second display panel unit 300. The first and second display panel units 200 and 300 include a plurality of pixels. An image is formed on the display panel 100 by a pixel voltage applied to the respective pixels. The controller 420 applies the pixel voltage to the respective pixels of the first display panel unit 200. Meanwhile, the controller 420 applies a pixel voltage to a display block unit having at least two pixels of the second display panel unit 300. FIG. 3 illustrates a display block unit of the display panel 100 according to the present exemplary embodiment. As shown therein, the first display panel unit 200 includes a plurality of pixels 240 to display an image while the second display panel unit 300 includes a plurality of pixels 340. A single display block 350 refers to a display region having at least two pixels 340.

The image signal is properly adjusted by the number of pixels of the display panel units 200 and 300, i.e., by resolution. The image signal which is applied to the respective pixels has a gray scale to realize an image. The controller 420 may control the gray scale of the image signal by a predetermined operation. The display block 350 receives the block image signal having an approximate gray scale of the image signal corresponding to the pixels 340, instead of receiving an image signal corresponding to the respective pixels. The signal processor 410 according to the present exemplary embodiment calculates an intermediate gray scale value of the image signal corresponding to the pixels 340 of the display block 350 according to a control of the controller 420. That is, the pixels 340 of the display block 350 receive the image signal having the intermediate gray scale value according to a predetermined operation. According to the block image signal applied to the display block 350, the second display panel unit 300 displays an achromatic color image like a mosaic pattern image. The display apparatus according to the present exemplary embodiment is driven as described above, and displays a bright image more brightly, and displays a dark image darker. The second display panel unit 300 displays an achromatic color image and adjusts transmissivity of light emitted by the backlight assembly 500. That means the second display panel unit 300 performs a local dimming to partially adjust light emitted by the backlight assembly 500.

The signal processor 420 may calculate the gray scale of the block image signal with various formulas having a plurality of coefficients, or may include a predetermined lookup table and determine the gray scale of the block image signal by using data of the lookup table, instead of calculating an intermediate gray scale value of the image signal to generate the block image signal.

If the image signal of the second display panel unit 300 is not processed into the block image signal, the two display panel units 200 and 300 overlap each other, thereby misaligning the wires formed in the respective display panel units 200 and 300. In this case, the pixels 240 and 340 overlap each other, and the image signal may not be properly displayed. Also, the image is not displayed clearly. According to the present exemplary embodiment, the pixel voltage is applied to the display block 350 of the second display panel unit 300, and the display block 350 displaying white or black color is used as a local dimming means, to prevent the decline in the image quality.

The backlight assembly 500 is disposed close to a surface of the first and second display panel units 200 and 300, and uniformly supplies light to the first and second display panel units 200 and 300. The backlight assembly 500 may include a lamp unit and an optical member which diffuses light emitted by the lamp unit. The lamp unit may include a cold cathode fluorescent lamp (CCFL), an external electrode fluorescent lamp (EEFL) and a hot cathode fluorescent lamp (HCFL).

The backlight assembly 500 may include a surface light source as the lamp unit, or a light emitting diode (LED) and an inorganic light emitting diode. The display apparatus according to the present exemplary embodiment may include various known backlight assemblies 500.

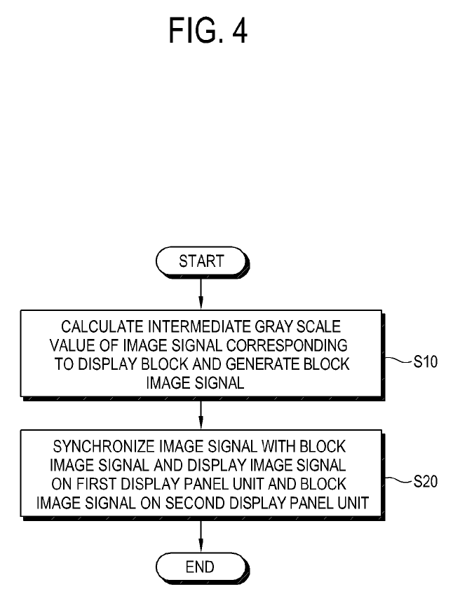

FIG. 4 is a flowchart that describes a method of controlling the display apparatus 1 according to the present exemplary embodiment.

The display apparatus 1 is provided with the first display panel unit 200 to display a chromatic color image, the second display panel unit 300 to display an achromatic color image, and the backlight assembly 500 to emit light to the first and second display panel units 200 and 300.

The signal processor 410 calculates the intermediate gray scale value of an image signal corresponding to the display block 350 and generates the block image signal (S10), in response to an image signal being input.

The image signal which is processed as a predetermined format is synchronized with the generated block image signal, and is displayed on the first display panel unit 200 (S20). Also, the synchronized block image signal is displayed on the second display panel unit 300 (S20).

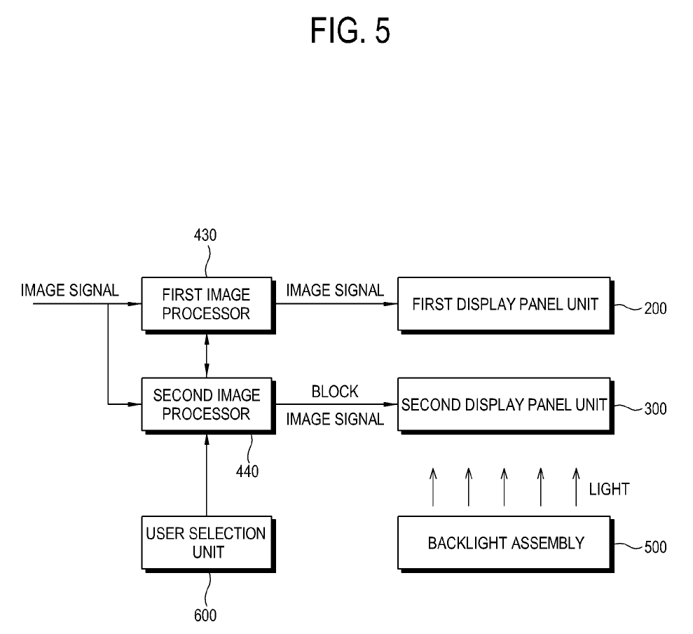

FIG. 5 is a block diagram of a display apparatus according to a second exemplary embodiment of the present invention.

As shown in FIG. 5, the display apparatus according to the present exemplary embodiment includes a first display panel unit 200, a second display panel unit 300, a first image processor 430, a second image processor 440, a user selection unit 600 and a backlight assembly 500. The description of the second exemplary embodiment does not include a description of the elements which have been described earlier.

The first image processor 430 processes an inputted image signal into a predetermined format, and supplies the image signal to the first display panel unit 200. The first image processor 430 includes a printed circuit board (PCB) which has various image processing circuits such as a gate driver, a data driver and a timing controller for controlling the gate driver and the data driver connected with a liquid crystal display panel by a flexible film.

The second image processor 440 generates the block image signal based on the gray scale of the inputted image signal, and applies the block image signal to the display block of the second display panel unit 300. The second image processor 440 includes a printed circuit board (PCB) which has various image processing circuits such as a gate driver, a data driver and a timing controller for controlling the gate driver and the data driver connected with a liquid crystal display panel by a flexible film.

If the equivalent image signals are inputted to the first and second image processor 430 and 440, the image signals corresponding to a single frame are synchronized with each other and supplied to the display panel units 200 and 300, respectively. The first and second image processors 430 and 440 may communicate with each other, and may perform functions of the controller 420 described according to the first exemplary embodiment. The user selection unit 600 is provided to adjust the contrast ratio. A user may control whether to drive the second display panel unit 300 through the user selection unit 600. That is, the second display panel unit 300 may be driven or not depending on the user's selection. The user selection unit 600 may include a shortcut button or a touch pad provided in a housing of the display apparatus, or may include general input devices such as a remote controller, a mouse and a keyboard.

According to another exemplary embodiment, the display apparatus may include an organic light emitting diode (OLED) and a plasma display panel (PDP), instead of the liquid crystal display apparatus. If the display panel includes the OLED or a PDP, the backlight assembly may be excluded therefrom. That is, the display apparatus may vary as long as two display panels overlap each other and the first display panel unit 200 displays a chromatic color image while the second display panel unit 300 displays an achromatic color image having brightness. If the display apparatus includes the OLED, the second display panel unit 300 is driven by a passive matrix method and includes a white organic light emitting material to display brightness only. If the display apparatus includes the PDP, red, green and blue light emitting materials may not be formed in pixels. Instead, a fluorescent substance emitting white light may be formed in a single pixel.

The display apparatus according to exemplary embodiments of the present invention displays the image through the display panel 100 having a pair of panel units performing different functions. More specifically, the display panel 100 includes the first display panel unit 200 to display an image substantially, and the second display panel unit 300 to improve the contrast ratio of the image displayed on the first display panel unit 200. Thus, the display apparatus displays an image having a relatively high contrast ratio.

As described above, exemplary embodiments of the present invention provide a display apparatus which improves contrast ratio and image quality, and a control method thereof.

Also, an exemplary embodiment of the present invention provides a display apparatus which reduces production costs, and a control method thereof.

Further, an exemplary embodiment of the present invention provides a display apparatus which realizes a local dimming by using two panels, and a control method thereof.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a first display panel unit which comprises a color filter;
a second display panel unit which faces the first display panel unit, and comprises a plurality of display blocks;
a signal processor; and
a controller which controls the signal processor to process an inputted image signal to be displayed on the first display panel, and to display a block image signal generated based on a gray scale of the image signal, on the second display panel unit.

2. The display apparatus according to claim 1, wherein each of the plurality of display blocks comprise a plurality of pixels, and
the gray scale of the block image signal is an intermediate gray scale value of the image signal corresponding to the plurality of pixels of the plurality of display blocks.

3. The display apparatus according to claim 1, wherein the second display panel unit displays an achromatic color image thereon.

4. The display apparatus according to claim 1, wherein the second display panel unit comprises a passive matrix (PM) liquid crystal panel.

5. The display apparatus according to claim 4, wherein the second display panel unit comprises a super twisted nematic mode (TN mode) liquid crystal panel.

6. The display apparatus according to claim 1, wherein the first display panel unit comprises an active matrix (AM) liquid crystal panel which uses a thin film transistor (TFT).

7. The display apparatus according to claim 6, wherein the first display panel unit comprises a vertically aligned (VA) mode liquid crystal panel.

8. The display apparatus according to claim 1, further comprising a backlight assembly which supplies light to the first and second display panel units.

9. The display apparatus according to claim 8, wherein the backlight assembly comprises at least one of a cold cathode fluorescent lamp (CCFL), an external electrode fluorescent lamp (EEFL) and a hot cathode fluorescent lamp (HCFL).

10. A display apparatus comprising:
a first display panel unit which comprises a color filter;
a second display panel unit which faces the first display panel unit and is divided into a plurality of display blocks;
a first image processor which processes an image signal to be displayed on the first display panel unit;
a second image processor which generates a block image signal based on a gray scale of the image signal, the block image signal to be applied to the plurality of display blocks, and displays the block image signal on the second display panel unit; and
a backlight assembly which supplies light to the first and second display panel units.

11. The display apparatus according to claim 10, wherein the second display panel unit displays an achromatic color image thereon.

12. The display apparatus according to claim 10, wherein each of the plurality of display blocks comprise a plurality of pixels, and
the gray scale of the block image signal is an intermediate gray scale value of the image signal corresponding to the plurality of pixels of the plurality of display blocks.

13. The display apparatus according to claim 10, wherein the second display panel unit comprises a passive matrix (PM) liquid crystal panel.

14. The display apparatus according to claim 10, further comprising a user selection unit for adjusting a contrast ratio.

15. A method of controlling a display apparatus which comprises a first display panel unit having a color filter, and a second display panel unit facing the first display panel unit and divided into a plurality of display blocks, the control method comprising:
generating a block image signal based on a gray scale of an inputted image signal, the block image signal to be applied to the plurality of the display blocks; and
applying the inputted image signal to the first display panel unit and applying the block image signal to the second display panel unit.

16. The control method according to claim 15, wherein each of the plurality of display blocks comprises a plurality of pixels, and
the generating the block image signal comprises calculating an intermediate gray scale value of the image signal corresponding to the plurality of pixels of the plurality of display blocks.

17. The display apparatus of claim 14, wherein the contrast ratio is adjusted by selecting whether to drive the second display panel unit, and the selecting is accomplished using the user selection unit.
